(19) United States
(12) Patent Application Publication
(10) Pub. No.: US 2025/0233345 A1
(43) Pub. Date: Jul. 17, 2025

(54) CONDUCTOR

(71) Applicant: Yazaki Corporation, Tokyo (JP)

(72) Inventors: Takayuki Mizunuma, Tochigi (JP); Yusuke Katazawa, Tochigi (JP); Chikara Katono, Tochigi (JP); Atsushi Okada, Tochigi (JP)

(21) Appl. No.: 18/984,267

(22) Filed: Dec. 17, 2024

(30) Foreign Application Priority Data
Jan. 17, 2024 (JP) 2024-005339

(51) Int. Cl. H01R 13/506; H01R 13/424; H01R 25/14

(52) U.S. Cl. CPC H01R 13/506; H01R 13/424; H01R 25/145

(57) ABSTRACT

A conductor includes a plate-shaped bus bar, and an exterior component attached to the bus bar. The bus bar includes a conductor portion and an insulating sheath with which the conductor portion is covered, and at least partially includes an attached portion having a twisted shape in which the bus bar extends while being twisted around an axis of the bus bar. The exterior component includes a body portion having a groove portion extending so as to be capable of accommodating the attached portion of the bus bar, and a cover portion capable of opening and closing an opening portion of the groove portion.

### CROSS-REFERENCE TO RELATED APPLICATIONS

This application is based on and claims priority under 35 USC 119 from Japanese Patent Application No. 2024-005339 filed on Jan. 17, 2024, the entire content of which is incorporated herein by reference.

### TECHNICAL FIELD

The present disclosure relates to a conductor including a plate-shaped bus bar and an exterior component attached to the bus bar.

### BACKGROUND ART

In the related art, when routing a metal bus bar in an automobile or the like, it has been proposed to assemble an insulating exterior component so as to cover the bus bar and, if necessary, to fix the exterior component to a vehicle body or the like of the automobile or the like as disclosed in, for example, JP2018-190532A.

The above type of bus bar generally has a shape extending along a predetermined routing path (so-called a layout) according to the specifications of the automobile or the like. Similarly, the exterior component generally has a shape corresponding to the routing path so that such a bus bar can be accommodated. In other words, the exterior component has a dedicated shape that differs for each specification of the bus bar. Therefore, as a matter of course, if the shape of the bus bar is different, the shape of the exterior component is also different. On the contrary, if the exterior component is generalized, a degree of design freedom in the shape of the bus bar decreases. For this reason, it is generally difficult to achieve both improvement of the degree of design freedom in the shape of the bus bar and improvement of versatility of the exterior component.

The present disclosure provides a conductor capable of achieving both improvement of a degree of design freedom in a shape of a bus bar and improvement of versatility of an exterior component.

In order to achieve the above object, the conductor according to the present disclosure is characterized as follows.

### SUMMARY

According to the present disclosure, a conductor includes a plate-shaped bus bar, and an exterior component attached to the bus bar. The bus bar includes a conductor portion and an insulating sheath with which the conductor portion is covered, and at least partially includes an attached portion having a twisted shape in which the bus bar extends while being twisted around an axis of the bus bar. The exterior component includes a body portion having a groove portion extending so as to be capable of accommodating the attached portion of the bus bar, and a cover portion capable of opening and closing an opening portion of the groove portion.

According to the conductor of the present disclosure, the bus bar includes the conductor portion covered with the insulating sheath, and at least partially includes the attached portion having a twisted shape in which the bus bar extends while being twisted around the axis of the bus bar. The attached portion is used to attach the bus bar and the exterior component. Specifically, the attached portion of the bus bar is accommodated in the groove portion of the exterior component. In this way, the conductor portion of the bus bar is covered with the insulating sheath, and thus it is not necessary to provide the exterior component so as to cover the entire bus bar. Furthermore, the exterior component only needs to have the groove portion capable of accommodating the attached portion having a twisted shape and the cover portion that opens and closes the groove portion, and does not need to have a dedicated shape for each shape (for example, a layout) of the bus bar. Accordingly, versatility of the exterior component can be improved. On the other hand, in the bus bar, a shape (for example, a layout) of a location other than the attached portion can be designed without considering the presence of the exterior component. Accordingly, the degree of design freedom in the shape of the bus bar can be improved. Therefore, the conductor of the present configuration can achieve both the improvement of the degree of design freedom in the shape of the bus bar and the improvement of the versatility of the exterior component.

Further, as another effect, the attached portion having a twisted shape is accommodated in the exterior component, and thus it is possible to prevent the exterior component from being displaced in an axial direction of the bus bar (so-called occurrence of a position deviation) as compared with a case in which a portion of the bus bar extending in a linear shape without the twisted shape is accommodated in the exterior component. Furthermore, for example, an unintended short circuit between the bus bars can be prevented by individually attaching exterior components to a positive electrode bus bar and a negative electrode bus bar. In addition, it is possible to reduce a size of the exterior component or to improve a workability of a work of attaching the exterior component to the bus bar.

The present disclosure is briefly described above. Further, details of the present disclosure will be clarified by reading modes for carrying out the disclosure to be described below with reference to the accompanying drawings.

### BRIEF DESCRIPTION OF DRAWINGS

FIG. 1 is a perspective view of a pair of conductors in a case in which a conductor according to an embodiment of the present disclosure is used as both a positive electrode conductor and a negative electrode conductor;

FIG. 2 is a perspective view showing a state in which a bus bar and an exterior component are separated from each other in one of the conductors shown in FIG. 1;

FIG. 3 is a top view of the conductor shown in FIG. 1;

FIG. 4 is a cross-sectional view taken along a line A-A in FIG. 3;

FIG. 5 is a cross-sectional view taken along a line B-B in FIG. 3;

FIG. 6 is a cross-sectional view taken along a line C-C in FIG. 3;

FIG. 7 is a view corresponding to FIG. 1 in a modification;

FIG. 8 is a view corresponding to FIG. 2 in the modification shown in FIG. 7;

FIG. 9A is a perspective view of a cover portion according to the modification shown in FIG. 7 as viewed from the rear and below; FIG. 9B is a perspective view of a body portion in the modification shown in FIG. 7 as viewed from the rear and above;

FIG. 10 is a view corresponding to FIG. 3 in the modification shown in FIG. 7;

FIG. 11 is a cross-sectional view taken along a line D-D in FIG. 10;

FIG. 12 is a cross-sectional view taken along a line E-E in FIG. 10; and

FIG. 13 is a cross-sectional view taken along a line F-F in FIG. 10.

### DESCRIPTION OF EMBODIMENTS

### Embodiment

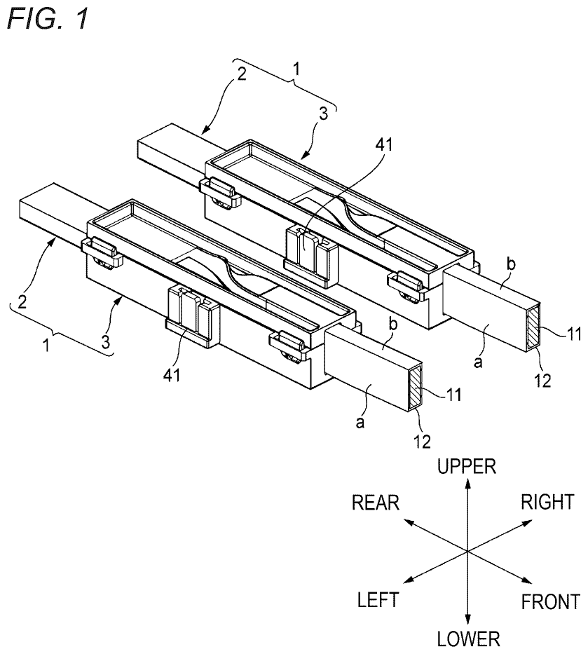

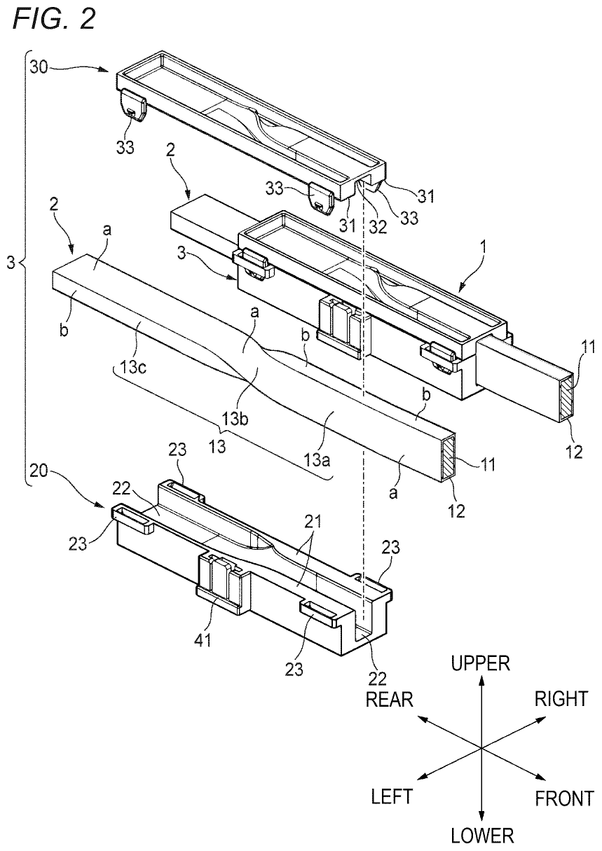

Hereinafter, a conductor 1 according to an embodiment of the present disclosure will be described with reference to the drawings. As shown in FIGS. 1 and 2 and the like, the conductor 1 includes a bus bar 2 and an exterior component 3 attached to an attached portion 13, which is a part of the bus bar 2 in an extending direction. In FIGS. 1 and 2 and the like, only the attached portion 13 is shown on the bus bar 2. Typically, the conductor 1 is used by being mounted on an automobile or the like in a state in which the bus bar 2 is routed in the automobile or the like, and the exterior component 3 attached to the attached portion 13 of the bus bar 2 is fixed to a vehicle body or the like of the automobile or the like. FIGS. 1 and 2 show an example in which a pair of conductors 1 to which the exterior components 3 are respectively attached are arranged at intervals on the attached portion 13 of the positive electrode bus bar 2 (in this example, a right side in FIG. 2) and the attached portion 13 of the negative electrode bus bar 2 (in this example, a left side in FIG. 2).

Hereinafter, for convenience of description, “front”, “rear”, “left”, “right”, “upper”, and “lower” are defined as shown in FIG. 1 or the like. A “front-rear direction”, a “left-right direction”, and an “upper-lower direction” are orthogonal to one another. The front-rear direction coincides with the extending direction (axial direction) of the attached portion 13 of the bus bar 2 and an extending direction of the exterior component 3. These directions are merely defined for the convenience of description, and do not necessarily correspond to, for example, the front-rear direction, the left-right direction, and the upper-lower direction of the automobile or the like when the conductor 1 is mounted on the automobile or the like. Hereinafter, a configuration of each component constituting the conductor 1 will be described in order.

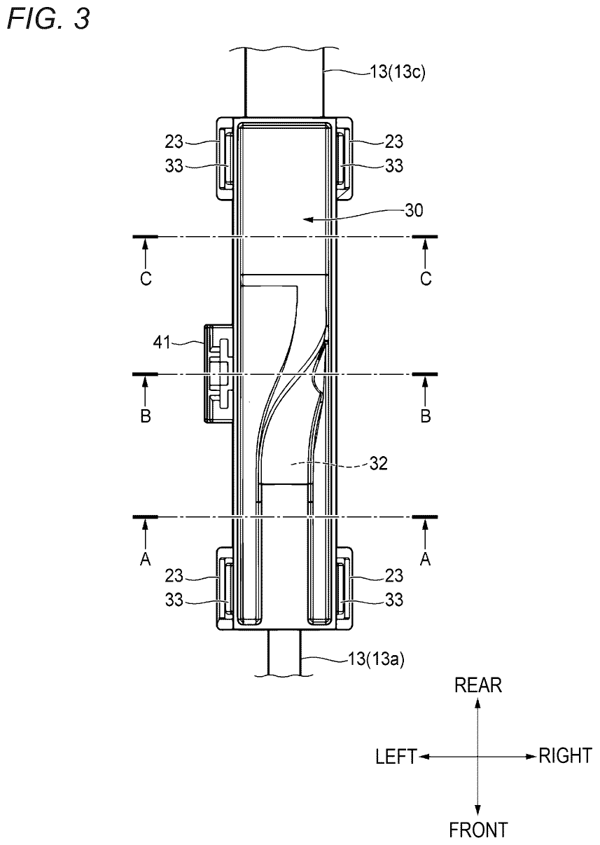

First, the bus bar 2 will be described. The bus bar 2 has a shape (for example, a shape extending while being bent three-dimensionally) extending along a routing path according to the specifications of the automobile or the like, and includes a conductor portion 11 that extends in the above shape and an insulating sheath 12 with which an outer periphery of the conductor portion 11 is covered (see FIG. 2). In this example, in a portion shown in FIGS. 1 to 3, which is a part of the bus bar 2 in the extending direction, the conductor portion 11 is a metal plate having a rectangular cross section and extending in an elongated shape, and the insulating sheath 12 covers the outer periphery of the conductor portion 11 over an entire region of the conductor portion 11 in the extending direction. A shape of a portion (not shown) of the bus bar 2 may be determined based on the specifications or the like of the bus bar 2, and may not necessarily have a linear shape.

As shown in FIGS. 1 to 3, the bus bar 2 has, as the attached portion 13, a portion (that is, a portion in which the conductor portion 11 is covered with the insulating sheath 12) extending in the front-rear direction in the part in the extending direction. The attached portion 13 has a rectangular cross-sectional shape as described above over the entire region in the extending direction (front-rear direction). Therefore, as shown in FIG. 2, an outer face extending in the extending direction of the attached portion 13 includes a pair of side faces a that are arranged to face each other in a thickness direction of (conductor portion 11 constituting the attached portion 13) the attached portion 13 and a pair of side faces b that are arranged to face each other in a width direction of (conductor portion 11 constituting the attached portion 13) the attached portion 13. In this example, the entire region of the conductor portion 11 itself in the extending direction is covered with the insulating sheath 12, and thus it is not necessary to provide the exterior component 3 so as to cover the entire region of the bus bar 2 in the extending direction. Therefore, in this example, the exterior component 3 is attached to the bus bar 2 so as to cover (accommodate) only (a part or the whole in the extending direction of) the attached portion 13, which is a part of the bus bar 2 in the extending direction. Accordingly, the exterior component 3 only needs to be capable of accommodating only (a part or the whole in the extending direction of) the attached portion 13 of the bus bar 2, and does not need to have a dedicated shape for each bus bar, and thus has high versatility. On the other hand, in the bus bar 2, a shape of a location other than the attached portion 13 can be designed without considering the presence of the exterior component 3. Accordingly, a degree of design freedom in the shape of the bus bar 2 is high.

As shown in FIG. 2, the attached portion 13 of the bus bar 2 has a portion having a twisted shape that extends while being twisted by 90 degrees around an axis of the attached portion 13 in a central portion in the extending direction (front-rear direction). Therefore, specifically, the attached portion 13 of the bus bar 2 integrally includes a vertical portion 13a that extends in the front-rear direction while maintaining a direction in which the thickness direction coincides with the left-right direction and forms a front portion of the attached portion 13, a twisted portion 13b that has the twisted shape, extends in the front-rear direction, and forms the central portion of the attached portion 13 in the extending direction, and a horizontal portion 13c that extends in the front-rear direction while maintaining a direction in which the thickness direction coincides with the upper-lower direction and forms a rear portion of the attached portion 13.

Next, the exterior component 3 will be described. The exterior component 3 is a resin molded body, and as shown in FIG. 2, includes a body portion 20 extending in the front-rear direction, and a cover portion 30 that is separate from the body portion 20, extends in the front-rear direction, and is capable of opening and closing an opening portion of the groove portion 22 (to be described later) of the body portion 20.

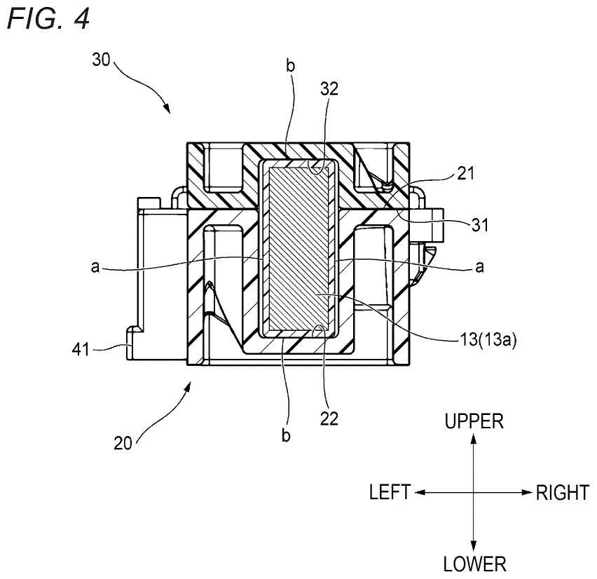

As shown in FIG. 2, the body portion 20 has a substantially rectangular parallelepiped shape extending in the front-rear direction. An upper face 21 (flat face facing upward) of the body portion 20 is provided with the groove portion 22 that is recessed downward, opens upward, and penetrates in the front-rear direction. The groove portion 22 accommodates the attached portion 13 (=vertical portion 13a+twisted portion 13b+horizontal portion 13c) of the bus bar 2 (see FIGS. 4 to 6). A face shape of a groove inner wall of the groove portion 22 will be described later in detail. Engaged portions 23 are provided at both end portions in the front-rear direction and both end portions in the left-right direction of the body portion 20 (four locations in total). Each engaged portion 23 is engaged with a corresponding engaging portion 33 (to be described later) of the cover portion 30. A fixing portion 41 to be fixed to the vehicle body or the like of the automobile or the like is provided at a center portion in the front-rear direction of an outer face of a left side wall of the body portion 20.

As shown in FIG. 2, the cover portion 30 has a substantially rectangular flat plate shape extending in the front-rear direction corresponding to a shape of the upper face 21 of the body portion 20. A lower face 31 (flat face facing downward) of the cover portion 30 is provided with a groove portion 32 that is recessed upward, opens downward, and extends in the front-rear direction. The groove portion 32 accommodates the vertical portion 13a and the twisted portion 13b of the attached portion 13 of the bus bar 2 (see also FIGS. 4 to 6). Therefore, the groove portion 32 extends from a front end of the cover portion 30 in the front-rear direction to an intermediate portion between a rear end and a center in the front-rear direction. A face shape of a groove inner wall of the groove portion 32 will be described later in detail. The engaging portions 33 are provided at both end portions in the front-rear direction and both end portions in the left-right direction of the cover portion 30 (four locations in total) so as to correspond to the engaged portions 23 of the body portion 20. In this example, the engaging portion 33 is a locking piece having a locking protrusion, and the engaged portion 23 is a locking hole into which an engaging piece is inserted to lock the locking protrusion. The configuration of each component constituting the conductor 1 has been described above.

Next, a procedure for attaching the exterior component 3 to the bus bar 2 will be described. In order to attach the exterior component 3 to the bus bar 2, first, as shown in FIG. 2, the attached portion 13 (=vertical portion 13a+twisted portion 13b+horizontal portion 13c), which is a part of the bus bar 2 in the extending direction, is accommodated in the groove portion 22 with respect to the body portion 20 in a state in which the cover portion 30 is separated. Next, the cover portion 30 is assembled to the body portion 20 such that the vertical portion 13a and the twisted portion 13b of the attached portion 13 are accommodated in the groove portion 32, and the lower face 31 of the cover portion 30 and the upper face 21 of the body portion 20 are in face contact with each other (see FIGS. 4 to 6). Accordingly, the attachment of the exterior component 3 to the bus bar 2 is completed, and the conductor 1 in the assembled state shown in FIG. 1 is obtained. In the assembled state of the conductor 1, the cover portion 30 is maintained in a state of being firmly fixed to the body portion 20 by the engagement between the four engaging portions 33 and the four engaged portions 23.

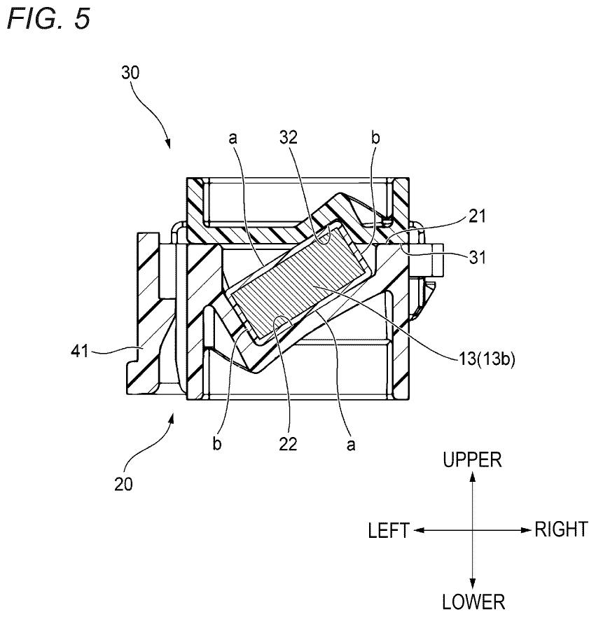

Hereinafter, the face shape of the groove inner wall of the groove portion 22 of the body portion 20 and the face shape of the groove inner wall of the groove portion 32 of the cover portion 30 will be described in detail. As shown in FIGS. 4 to 6, a face of the groove inner wall of the groove portion 22 of the body portion 20 has a face shape extending along the outer face of the attached portion 13 (=vertical portion 13a+twisted portion 13b+horizontal portion 13c) in a state of being accommodated in the groove portion 22 over the entire region in the front-rear direction while being in contact with or close to the outer face (see FIGS. 4 to 6). In particular, at a location at which the twisted portion 13b of the attached portion 13 is accommodated, the face of the groove inner wall of the groove portion 22 of the body portion 20 has a face shape that extends while being curved along the outer face of the twisted portion 13b corresponding to the twisted shape of the twisted portion 13b and while being in contact with or close to the outer face (see FIG. 5).

Similarly, a face of the groove inner wall of the groove portion 32 of the cover portion 30 has a face shape extending along the outer faces of the vertical portion 13a and the twisted portion 13b of the attached portion 13 in a state of being accommodated in the groove portion 32 over the entire region in the front-rear direction while being in contact with or close to the outer faces (see FIGS. 4 and 5). In particular, at a location at which the twisted portion 13b of the attached portion 13 is accommodated, the face of the groove inner wall of the groove portion 32 of the cover portion 30 has a face shape that extends while being curved along the outer face of the twisted portion 13b corresponding to the twisted shape of the twisted portion 13b and while being in contact with or close to the outer face (see FIG. 5).

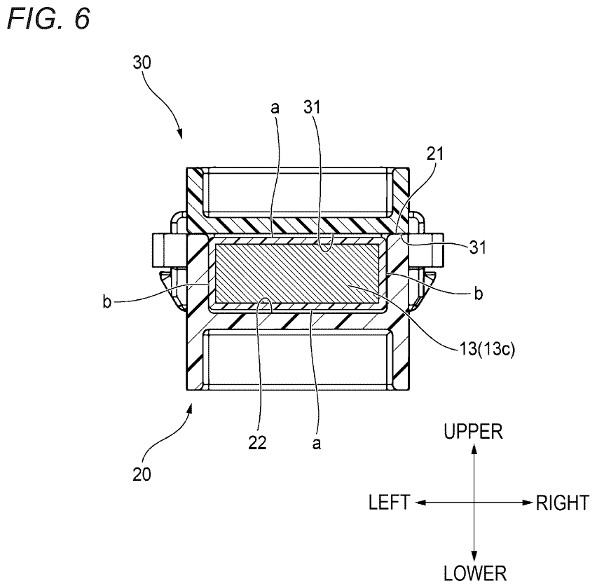

Therefore, in the assembled state of the conductor 1, in the vertical portion 13a and the twisted portion 13b of the attached portion 13, as shown in FIGS. 4 and 5, the pair of side faces a that are arranged to face each other in the thickness direction of the attached portion 13 are sandwiched in the thickness direction of the attached portion 13 by the groove inner wall of the groove portion 22 and the groove inner wall of the groove portion 32 (which are in contact with or close to each other), and the pair of side faces b that are arranged to face each other in the width direction of the attached portion 13 are sandwiched in the width direction of the attached portion 13 by the groove inner wall of the groove portion 22 and the groove inner wall of the groove portion 32 (which are in contact with or close to each other). In the horizontal portion 13c of the attached portion 13, as shown in FIG. 6, the pair of side faces a that are arranged to face each other in the thickness direction of the attached portion 13 are sandwiched in the thickness direction of the attached portion 13 by the groove inner wall of the groove portion 22 and the lower face 31 of the cover portion 30 (which are in contact with or close to each other), and the pair of side faces b that are arranged to face each other in the width direction of the attached portion 13 are sandwiched in the width direction of the attached portion 13 by only the groove inner wall of the groove portion 22 (which are in contact with or close to each other).

As described above, in the assembled state of the conductor 1, the exterior component 3 (=body portion 20+cover portion 30) sandwiches the attached portion 13 in the thickness direction and the width direction over the entire region in the extending direction of the attached portion 13 (=vertical portion 13a+twisted portion 13b+horizontal portion 13c) covered with the exterior component 3 in cooperation with the groove inner wall of the groove portion 22 of the body portion 20, the groove inner wall of the groove portion 32 of the cover portion 30, and the lower face 31 of the cover portion 30. Accordingly, it is possible to prevent the attached portion 13 of the bus bar 2 from being displaced in the thickness direction and the width direction in the exterior component 3 (so-called occurrence of rattling).

The conductor 1 that has been assembled is mounted on the automobile or the like in a state in which the bus bar 2 is routed in the automobile or the like and the fixing portion 41 (see FIG. 1 or the like) provided in the exterior component 3 attached to the attached portion 13 of the bus bar 2 is fixed to the vehicle body or the like of the automobile or the like.

When the bus bar 2 is detached from the exterior component 3 in the conductor 1 that has been assembled, first, the cover portion 30 is separated from the body portion 20 by disengaging the four engaged portions 23 of the body portion 20 and the four engaging portions 33 of the cover portion 30. Next, the attached portion 13 of the bus bar 2 is moved upward toward the outside of the groove portion 22 via the opening portion that opens above the groove portion 22 of the body portion 20. Accordingly, the work of detaching the bus bar 2 from the exterior component 3 is completed.

As shown in FIGS. 1 and 2, in a case in which the pair of conductors 1 to which the exterior components 3 are respectively attached are arranged at intervals on the attached portion 13 of the positive electrode bus bar 2 and the attached portion 13 of the negative electrode bus bar 2, when the work of detaching the bus bars 2 from the exterior component 3 is performed on each of the pair of conductors 1, it is possible to prevent one bus bar 2 from coming into contact with the other bus bar 2 by sufficiently forming an interval between the pair of conductors 1, thereby preventing an unintended short circuit between the bus bars 2.

### <Operation and Effect>

According to the conductor 1 according to the present embodiment, the bus bar 2 includes the conductor portion 11 covered with the insulating sheath 12, and at least partially includes the attached portion 13 having a twisted shape in which the bus bar 2 extends while being twisted around the axis of the bus bar 2. The attached portion 13 is used to attach the bus bar 2 and the exterior component 3. Specifically, the attached portion 13 of the bus bar 2 is accommodated in the groove portion 22 of the exterior component 3. In this way, the conductor portion 11 of the bus bar 2 is covered with the insulating sheath 12, and thus it is not necessary to provide the exterior component 3 so as to cover the entire bus bar 2. Furthermore, the exterior component 3 only needs to have the groove portion 22 capable of accommodating the attached portion 13 having a twisted shape and the cover portion 30 that opens and closes the groove portion 22, and does not need to have a dedicated shape for each bus bar 2. Accordingly, the versatility of the exterior component 3 can be improved. On the other hand, in the bus bar 2, a shape of a location other than the attached portion 13 can be designed without considering the presence of the exterior component 3. Accordingly, a degree of design freedom in the shape of the bus bar 2 can be improved. Therefore, the conductor 1 according to the present embodiment can achieve both the improvement of the degree of design freedom in the shape of the bus bar 2 and the improvement of the versatility of the exterior component 3.

Further, as another effect, the attached portion 13 having a twisted shape is accommodated in the exterior component 3, and thus it is possible to prevent the exterior component 3 from being displaced in the axial direction of the bus bar 2 (so-called occurrence of a position deviation) as compared with a case in which a portion of the bus bar 2 extending in a linear shape without the twisted shape is accommodated in the exterior component 3. Furthermore, for example, the unintended short circuit between the bus bars can be prevented by individually attaching the exterior components 3 to the positive electrode bus bar 2 and the negative electrode bus bar 2. In addition, it is possible to reduce a size of the exterior component 3 or to improve a workability of a work of attaching the exterior component 3 to the bus bar 2.

The exterior component 3 is implemented such that the attached portion 13 of the bus bar 2 is sandwiched in the thickness direction of the bus bar 2 by the body portion 20 and the cover portion 30. Accordingly, it is possible to prevent the bus bar 2 from being displaced in the thickness direction in the groove portion 22 of the exterior component 3 (so-called the occurrence of rattling).

Further, the groove inner wall of the groove portion 22 of the body portion 20 and the groove inner wall of the groove portion 32 of the cover portion 30 of the exterior component 3 each have a face shape curved along the outer face of the attached portion 13 corresponding to the twisted shape of the attached portion 13. Accordingly, the groove inner wall of the body portion 20 and the groove inner wall of the cover portion 30 are easily brought into face contact with the bus bar 2, and thus it is possible to more effectively prevent the bus bar 2 from being displaced in the thickness direction in the groove portion 22 of the exterior component 3 (so-called the occurrence of rattling).

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the above embodiment (see FIGS. 1 to 6), in the assembled state of the conductor 1, a face formed by the groove inner wall of the groove portion 22 of the body portion 20, the groove inner wall of the groove portion 32 of the cover portion 30, and the lower face 31 of the cover portion 30 has a face shape extending along the outer face of the attached portion 13 (=vertical portion 13a+twisted portion 13b+horizontal portion 13c) of the bus bar 2 covered with the exterior component 3 while being in contact with or close to the outer face over the entire region in the front-rear direction (see FIGS. 4 to 6), whereby the exterior component 3 (=body portion 20+cover portion 30) sandwiches the attached portion 13 (=vertical portion 13a+twisted portion 13b+horizontal portion 13c) covered with the exterior component 3 in the thickness direction and the width direction over the entire region in the extending direction of the attached portion 13 in the assembled state of the conductor 1.

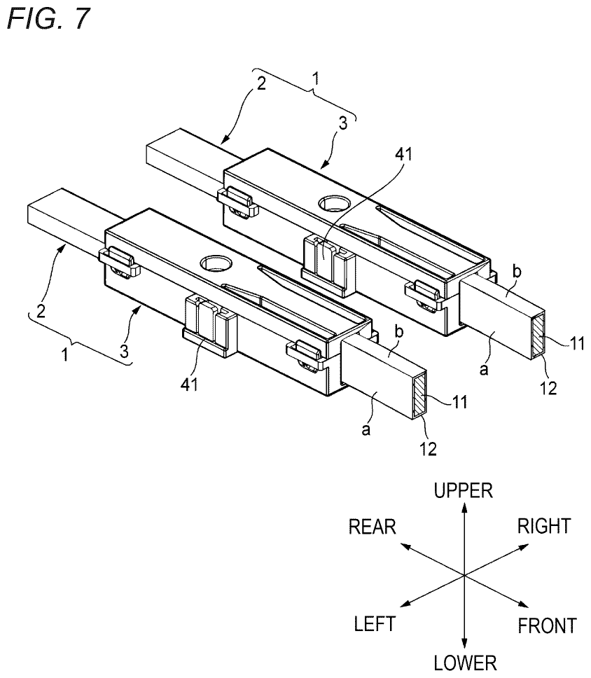

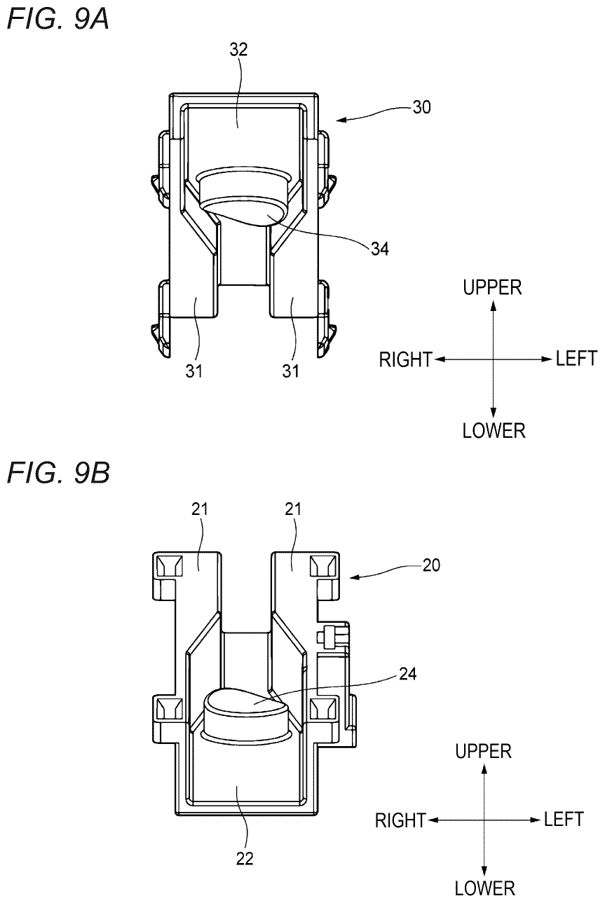

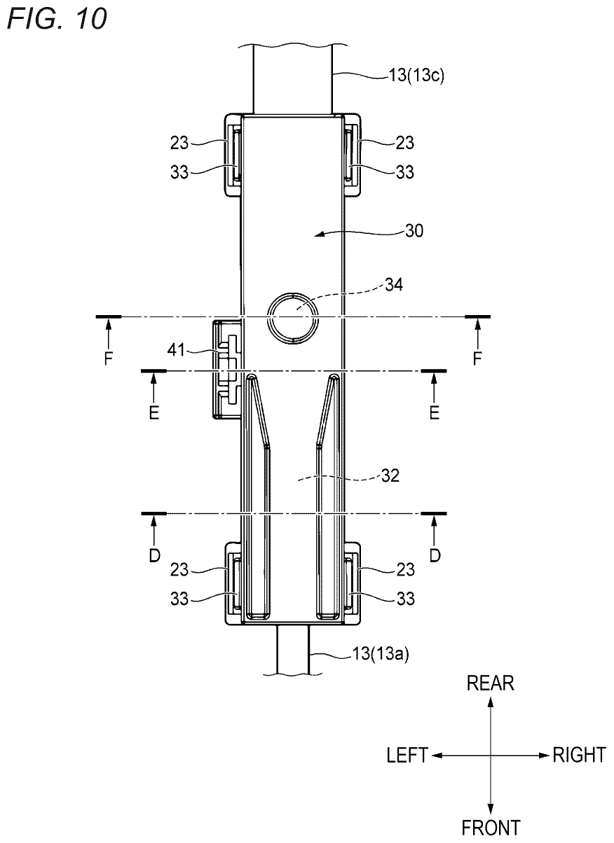

On the other hand, in the modification shown in FIGS. 7 to 13, the face of the groove inner wall of the groove portion 22 penetrating the body portion 20 in the front-rear direction has a face shape extending along the outer face of the vertical portion 13a of the attached portion 13 of the bus bar 2 in the state of being accommodated in the groove portion 22 while being in contact with or close to the outer face, and extending away from the outer faces of the twisted portion 13b and the horizontal portion 13c of the attached portion 13 of the bus bar 2 in the state of being accommodated in the groove portion 22 (see FIGS. 10 to 13).

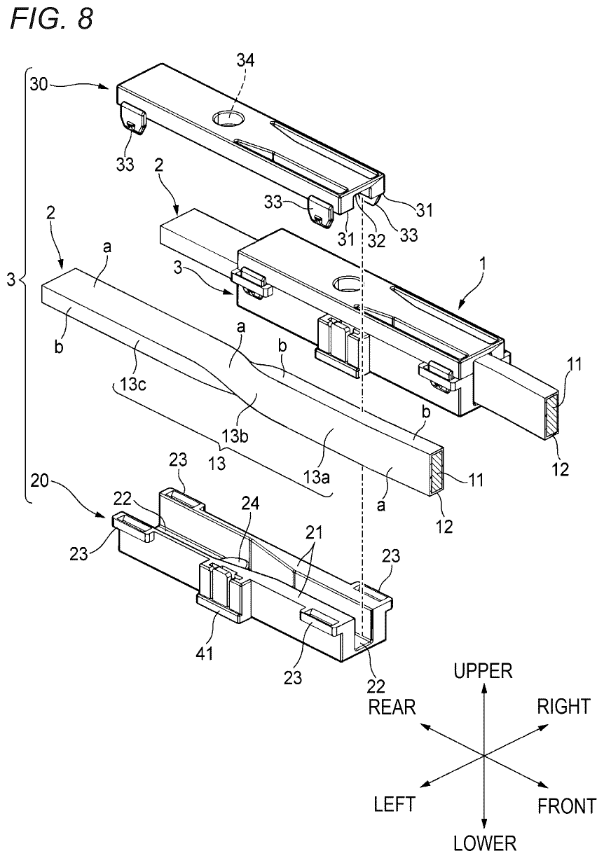

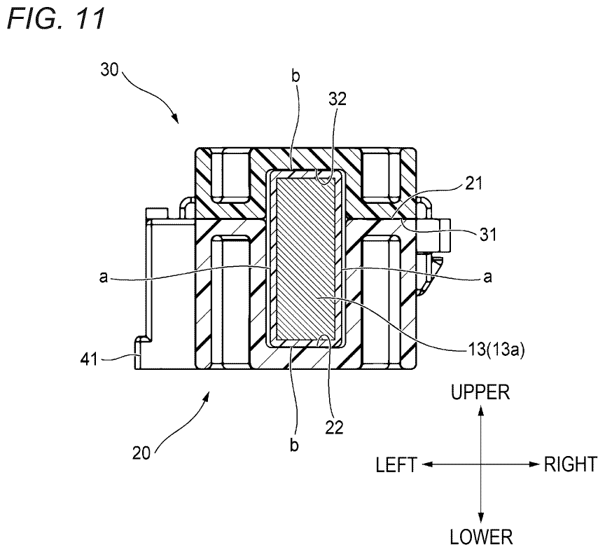

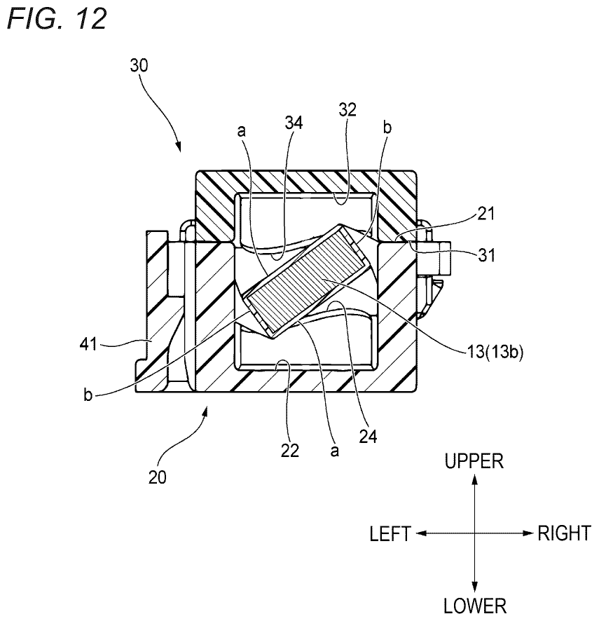

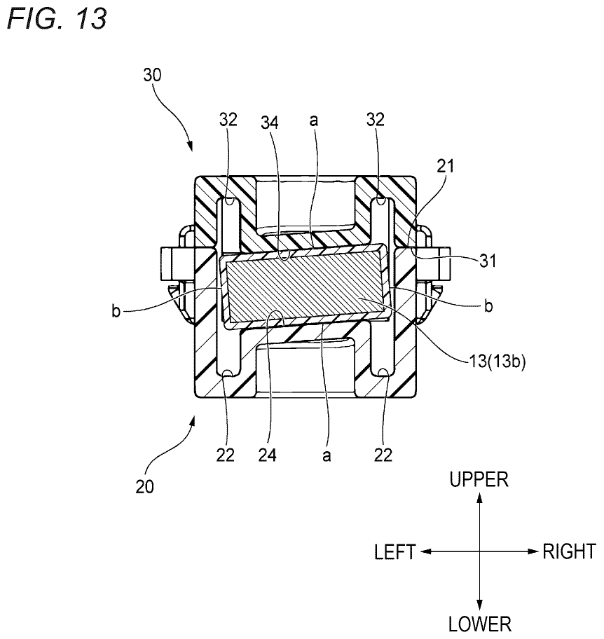

The groove portion 22 at a front-rear direction position corresponding to the twisted portion 13b of the attached portion 13 is formed with a first protruding portion 24 protruding upward toward the outer face of the twisted portion 13b of the attached portion 13 in the state of being accommodated in the groove portion 22 (see FIGS. 8, 9B, and 13). A protruding end face of the first protruding portion 24 has a face shape that is curved along the outer face of the twisted portion 13b of the attached portion 13 in the state of being accommodated in the groove portion 22 and is in contact with or close to the outer face (see FIGS. 12 and 13). Similarly, the face of the groove inner wall of the groove portion 32 penetrating the cover portion 30 in the front-rear direction has a face shape extending along the outer face of the vertical portion 13a of the attached portion 13 in the state of being accommodated in the groove portion 32 while being in contact with or close to the outer face, and extending away from the outer faces of the twisted portion 13b and the horizontal portion 13c of the attached portion 13 in the state of being accommodated in the groove portion 32 (see FIGS. 11 to 13). The groove portion 32 at a front-rear direction position corresponding to a front-rear direction position at which the first protruding portion 24 of the body portion 20 is provided is formed with a second protruding portion 34 protruding downward toward the outer face of the twisted portion 13b of the attached portion 13 in the state of being accommodated in the groove portion 32 (see FIGS. 8, 9A, and 13). A protruding end face of the second protruding portion 34 has a face shape that is curved along the outer face of the twisted portion 13b of the attached portion 13 in the state of being accommodated in the groove portion 32 and is in contact with or close to the outer face (see FIGS. 12 and 13).

Therefore, in the assembled state of the conductor 1, in the vertical portion 13a of the attached portion 13, as shown in FIG. 11, the pair of side faces a that are arranged to face each other in the thickness direction of the attached portion 13 are sandwiched in the thickness direction of the attached portion 13 by the groove portion 22 and the groove portion 32 (which are in contact with or close to each other), and the pair of side faces b that are arranged to face each other in the width direction of the attached portion 13 are sandwiched in the width direction of the attached portion 13 by the groove portion 22 and the groove portion 32 (which are in contact with or close to each other). Further, in the twisted portion 13b of the attached portion 13, as shown in FIGS. 12 and 13 (particularly, FIG. 13), the pair of side faces a that are arranged to face each other in the thickness direction of the attached portion 13 are sandwiched in the thickness direction of the attached portion 13 by the protruding end face of the first protruding portion 24 and the protruding end face of the second protruding portion 34 (which are in contact with or close to each other). As described above, in the assembled state of the conductor 1, the exterior component 3 (=body portion 20+cover portion 30) sandwiches the vertical portion 13a and the twisted portion 13b of the attached portion 13 covered with the exterior component 3 in the thickness direction in cooperation with the groove inner wall of the groove portion 22 of the body portion 20, the protruding end face of the first protruding portion 24 of the body portion 20, the groove inner wall of the groove portion 32 of the cover portion 30, and the protruding end face of the second protruding portion 34 of the cover portion 30. Accordingly, in the modification shown in FIGS. 7 to 13, it is possible to prevent the attached portion 13 of the bus bar 2 from being displaced in the thickness direction in the exterior component 3 (so-called occurrence of rattling).

Here, features of the embodiment of the conductor 1 according to the present disclosure described above are briefly summarized and listed in the following (i) to (iv).

(i)

A conductor (1) including:
a plate-shaped bus bar (2); and
an exterior component (3) attached to the bus bar (2), in which
the bus bar (2) includes a conductor portion (11) and an insulating sheath (12) with which the conductor portion (11) is covered, and at least partially includes an attached portion (13) having a twisted shape in which the bus bar (2) extends while being twisted around an axis of the bus bar (2), and
the exterior component (3) includes a body portion (20) having a groove portion (22) extending so as to be capable of accommodating the attached portion (13) of the bus bar (2), and a cover portion (30) capable of opening and closing an opening portion of the groove portion (22).

According to the conductor of the configuration of the above (i), the bus bar includes the conductor portion covered with the insulating sheath, and at least partially includes the attached portion having a twisted shape in which the bus bar extends while being twisted around the axis of the bus bar. The attached portion is used to attach the bus bar and the exterior component. Specifically, the attached portion of the bus bar is accommodated in the groove portion of the exterior component. In this way, the conductor portion of the bus bar is covered with the insulating sheath, and thus it is not necessary to provide the exterior component so as to cover the entire bus bar. Furthermore, the exterior component only needs to have the groove portion capable of accommodating the attached portion having a twisted shape and the cover portion that opens and closes the groove portion, and does not need to have a dedicated shape for each shape (for example, a layout) of the bus bar. Accordingly, versatility of the exterior component can be improved. On the other hand, in the bus bar, a shape (for example, a layout) of a location other than the attached portion can be designed without considering the presence of the exterior component. Accordingly, a degree of design freedom in the shape of the bus bar can be improved. Therefore, the conductor of the present configuration can achieve both the improvement of the degree of design freedom in the shape of the bus bar and the improvement of the versatility of the exterior component.

Further, as another effect, the attached portion having a twisted shape is accommodated in the exterior component, and thus it is possible to prevent the exterior component from being displaced in an axial direction of the bus bar (so-called occurrence of a position deviation) as compared with a case in which a portion of the bus bar extending in a linear shape without the twisted shape is accommodated in the exterior component. Furthermore, for example, an unintended short circuit between the bus bars can be prevented by individually attaching exterior components to a positive electrode bus bar and a negative electrode bus bar. In addition, it is possible to reduce a size of the exterior component or to improve a workability of a work of attaching the exterior component to the bus bar.

(ii)

The conductor (1) according to the above (i), in which
the exterior component (3) is implemented such that the attached portion (13) of the bus bar (2) is sandwiched in a thickness direction of the bus bar (2) by the body portion (20) and the cover portion (30).

According to the conductor of the configuration of (ii), the exterior component is implemented such that the attached portion of the bus bar is sandwiched in the thickness direction of the bus bar by the body portion and the cover portion. Accordingly, it is possible to prevent the bus bar from being displaced in the thickness direction in the groove portion of the exterior component (so-called occurrence of rattling).

(iii)

The conductor (1) according to above (ii), in which
the groove portion (22) of the body portion (20) has a groove inner wall having a shape curved along one outer face (lower right side face a in FIG. 5) of the attached portion (13) in the thickness direction corresponding to the twisted shape, and
the cover portion (30) has a cover wall (groove inner wall of the groove portion 32) having a shape curved along another outer face (upper left side face a in FIG. 5) of the attached portion (13) in the thickness direction corresponding to the twisted shape.

According to the conductor of the configuration of the above (iii), the groove inner wall of the body portion and the cover wall of the cover portion of the exterior component each have a face shape curved along the outer face of the attached portion corresponding to the twisted shape of the attached portion. Accordingly, the groove inner wall of the body portion and the cover wall are easily brought into face contact with the bus bar, and thus it is possible to more effectively prevent the bus bar from being displaced in the thickness direction in the groove portion of the exterior component (so-called the occurrence of rattling).

(iv)

The conductor (1) according to the above (ii), in which
the groove portion (22) of the body portion (20) includes a first protruding portion (24) having a protruding end face having a shape that protrudes toward one outer face of the attached portion (13) in the thickness direction and is curved along the one outer face (lower right side face a in FIG. 13) corresponding to the twisted shape, and
the cover portion (30) includes a second protruding portion (34) having a protruding end face having a shape that protrudes toward another outer face of the attached portion (13) in the thickness direction and is curved along the other outer face (upper left side face a in FIG. 13) corresponding to the twisted shape.

According to the conductor of the configuration of the above (iv), the protruding end face of the first protruding portion provided on the body portion and the protruding end face of the second protruding portion provided on the cover portion of the exterior component each have a face shape curved along the outer face of the attached portion corresponding to the twisted shape of the attached portion. Accordingly, the protruding end face of the first protruding portion and the protruding end face of the second protruding portion are easily brought into face contact with the bus bar, and thus it is possible to more effectively prevent the bus bar from being displaced in the thickness direction in the groove portion of the exterior component (so-called the occurrence of rattling).

What is claimed is:

1. A conductor comprising:
a plate-shaped bus bar; and
an exterior component attached to the bus bar, wherein
the bus bar includes a conductor portion and an insulating sheath with which the conductor portion is covered, and at least partially includes an attached portion having a twisted shape in which the bus bar extends while being twisted around an axis of the bus bar, and
the exterior component includes a body portion having a groove portion extending so as to be capable of accommodating the attached portion of the bus bar, and a cover portion capable of opening and closing an opening portion of the groove portion.

2. The conductor according to claim 1, wherein
the exterior component is implemented such that the attached portion of the bus bar is sandwiched in a thickness direction of the bus bar by the body portion and the cover portion.

3. The conductor according to claim 2, wherein
the groove portion of the body portion has a groove inner wall having a shape curved along one outer face of the attached portion in the thickness direction corresponding to the twisted shape, and
the cover portion has a cover wall having a shape curved along another outer face of the attached portion in the thickness direction corresponding to the twisted shape.

4. The conductor according to claim 2, wherein
the groove portion of the body portion includes a first protruding portion having a protruding end face having a shape that protrudes toward one outer face of the attached portion in the thickness direction and is curved along the one outer face corresponding to the twisted shape, and
the cover portion includes a second protruding portion having a protruding end face having a shape that protrudes toward another outer face of the attached portion in the thickness direction and is curved along the other outer face corresponding to the twisted shape.
